(19) United States
(12) Patent Application Publication
(10) Pub. No.: US 2002/0059371 A1
(43) Pub. Date: May 16, 2002

(54) Caching proxy streaming appliance systems and methods

(76) Inventors: John M. Jamail, Columbus, OH (US); Samson F. Creasey, Columbus, OH (US)

Correspondence Address: OLIFF & BERRIDGE, PLC, P.O. BOX 19928, ALEXANDRIA, VA, 22320, US

(21) Appl. No.: 09/970,767

(22) Filed: Oct. 5, 2001

Related U.S. Application Data
(60) Provisional application No. 60/248,842, filed on Nov. 16, 2000.

(51) Int. Cl. G06F 15/16; G06F 15/167

(52) U.S. Cl. 709/203; 709/213

(57) ABSTRACT

A client machine connects directly to a proxy server without the knowledge or without a programmed expectation that the proxy server will connect to another server at all. The client machine sends a request directly to the proxy server, expecting that the content requested by the client machine resides on the proxy server. The proxy server, if it does not contain the requested content, obtains the requested content from a second server without the client machine ever knowing that the content did not originally reside on the proxy server, and was instead obtained from the second server.

### BACKGROUND OF THE INVENTION

1. Field of Invention

This invention is directed to systems and methods for using a proxy server to cache and stream data streams.

2. Description of Related Art

Proxy servers are conventionally used in distributed network environments for a variety of purposes. Traditionally, a worldwide web proxy is implemented with the knowledge of the user. The user, communicating using a client machine, knows that a proxy server is present in the network. The user ultimately wishes to communicate with a destination server machine. The user also knows that the client machine must connect to this proxy server, rather than connecting to what the user believes to be the actual destination server. In this case, which is shown in FIG. 1, the client machine connects to the proxy server that it knows about over the network.

The client machine sends a message to the proxy server to inform the proxy server of the final destination server that the client machine wants to talk to. In general, the client machine does this by providing the website name or URL address of the actual destination server (server B) to the proxy server (server A), in addition to providing the file name on the actual destination server that is to be downloaded to the client machine, where server A indicates the server the client machine thinks he is communicating with, and server B is another server in the communication loop. In response, the proxy server connects to the actual destination server. The proxy server then retrieves the file from the actual destination server and sends that file back to the client machine.

This use of a proxy server is particularly useful when the client wants to retrieve a file having a predetermined length, and which has no special transport requirements, such as, for example, a web page, a program to be retrieved over the network, or the like, that are single pieces of data. In particular, this use of a proxy server is inappropriate for data streaming applications where the file may not have a fixed or predetermined length, and where the data is streamed such that there are significant transport requirements which must be met for the data to be properly streamed to the client machine.

Conventional transparent proxy servers are also used in distributed network environments. Conventional transparent proxy servers are proxy servers that are integrated into a network structure. Client machines often attempt to connect directly to actual destination servers that contain the files or data that the user wishes to download to the client machine. Thus, in this case, which is shown in FIG. 2, in contrast to the traditional proxy servers described above and shown in FIG. 1, the client machine initially attempts to connect directly to the actual destination server that contains the desired download file, by outputting a request directed to the website name or URL address of the actual destination machine and containing the file name of the file the user wishes to download or retrieve.

The distributed network hardware installed at the location of the client machine, or installed at an upstream point in the distributed network from the client, transparently intercepts this request. This distributed network hardware forwards the intercepted request to the transparent proxy server. The transparent proxy server determines the web site name or URL address of the actual destination server, and generates a new request to the actual destination machine for the file originally requested by the client machine. The transparent proxy server obtains the file from the actual destination machine and forwards the obtained file to the client machine.

Because this method of proxying is integrated into the network, the transparent proxy server is able to determine, from the network data, where the request from the client machine was originally destined for. As a result, the transparent proxy server can determine the actual destination server to connect to in order to retrieve the requested file.

Importantly, in conventional proxy servers, the client machine, and thus the user, never actually “sees” the proxy server. The client machine acts as if the client machine were directly connected to the actual destination server that the client machine originally submitted the request to. Thus, as far as the client machine knows, the client machine is communicating with the actual destination server (server A) when the client machine is really communicating with a transparent proxy server (server B). That is, to the client machine, the transparent proxy server is transparent in the sense that the client machine never sees the interaction of the transparent proxy server with the actual destination server. In other words, the client machine never knows that the transparent proxy server is there at all.

The transparent proxy server is particularly useful when the network administrator wants to control which servers the client machine directly communicates with. This is usually done to create firewalls between the client machine and a distributed network that the client machine can connect to. By using the transparent proxy server, virus-infected files and attacks by hackers on the client machine can be trapped and defended against.

### SUMMARY OF THE INVENTION

This invention provides systems and methods that implement a proxy server that communicates transparently with servers containing content desired by a client machine that are not known by the client machine.

This invention separately provides systems and methods that implement a proxy server that caches content obtained from another server as the proxy server transmits the content to a client machine.

This invention provides systems and methods that implement a proxy server that maps the locations of other servers from which the proxy server was able to obtain content requested by a client machine communicating with the proxy server.

In various exemplary embodiments of the systems and methods according to this invention, the client machine connects directly to the proxy server without the knowledge or without a programmed expectation that the proxy server will connect to another server at all. The client machine sends a request directly to the proxy server (server A) expecting that the content requested by the client machine resides on the proxy server. The proxy server, if it does not contain the requested content, obtains the requested content from a second server (server B) without the client machine ever knowing that the content did not originally reside on the proxy server, and was instead obtained from the server B.

These and other features and advantages of this invention are described in, or are apparent from, the following detailed description of various exemplary embodiments of the systems and methods according to this invention.

### BRIEF DESCRIPTION OF THE DRAWINGS

Various exemplary embodiments of this invention will be described in detail, with reference to the following figures, wherein:

FIG. 1 is a block diagram of a network including a first conventional proxy server;

FIG. 2 is a block diagram of a network including a second conventional proxy server;

FIG. 3 is a block diagram of a network including a first exemplary embodiment of a proxy server according to this invention;

FIG. 4 is a block diagram of a network including a second exemplary embodiment of a proxy server according to this invention;

FIG. 5 is a block diagram of a network including a third exemplary embodiment of a proxy server according to this invention;

FIG. 6 is a flowchart outlining a first exemplary embodiment of a method for responding to a content request according to this invention;

FIG. 7 is a flowchart outlining a second exemplary embodiment of a method for responding to a content request according to this invention;

FIG. 8 is a flowchart outlining a third exemplary embodiment of a method for responding to a content request according to this invention;

FIG. 9 is a flowchart outlining a fourth exemplary embodiment of a method for responding to a content request according to this invention;

FIG. 10 is a flowchart outlining a fifth exemplary embodiment of a method for responding to a content request according this invention; and

FIG. 11 is a sixth exemplary embodiment of a method for responding to a content request according to this invention.

### DETAILED DESCRIPTION OF EXEMPLARY EMBODIMENTS

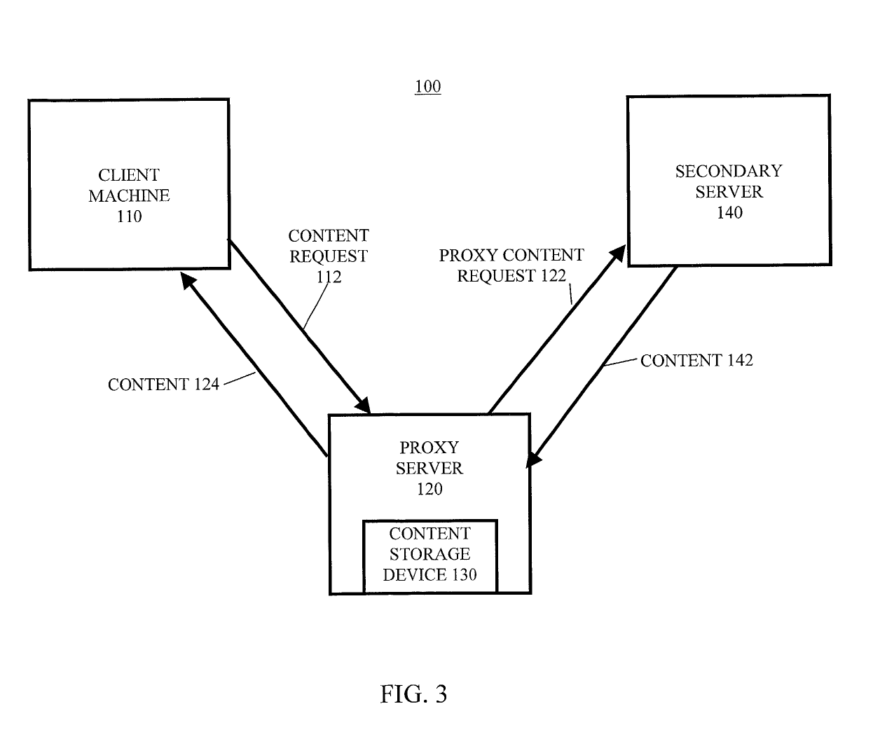

FIG. 3 is a block diagram of a network 100 including a first exemplary embodiment of a proxy server 120 according to this invention. As shown in FIG. 3, the network 100 includes a client machine 110, the proxy server 120 and any number of distinct secondary servers 140. The client machine 110 generates one or more requests 112 for content and directs these requests 112 directly to the proxy server 120. The proxy server 120 receives these requests 112 and transmits the requested content 124 back to the client machine.

Conventionally, the proxy server 120 would be able to transmit the requested content to the client machine 110 only if the requested content were previously stored in a content storage device 130 of the proxy server 120. Otherwise, the proxy server 120 would transmit an error message to the client machine 110.

In contrast, according to the systems and methods of this invention, if the proxy server 120 does not currently contain in the content storage device 130 the content identified in the request 112 from the client machine 110, the proxy server 120 contacts one of the secondary servers 140 of the network 100 that contains the requested content. In particular, the proxy server 120 generates a new request 122 and directs that request 122 to a particular one of the secondary servers 140 that is known to contain the content identified in the request 112. This secondary server 140, in response to the request 122, transmits the requested content 142 to the proxy server 120. The proxy server 120 then retransmits the content 142 received from the secondary server 140 to the client machine 110 as the content 124.

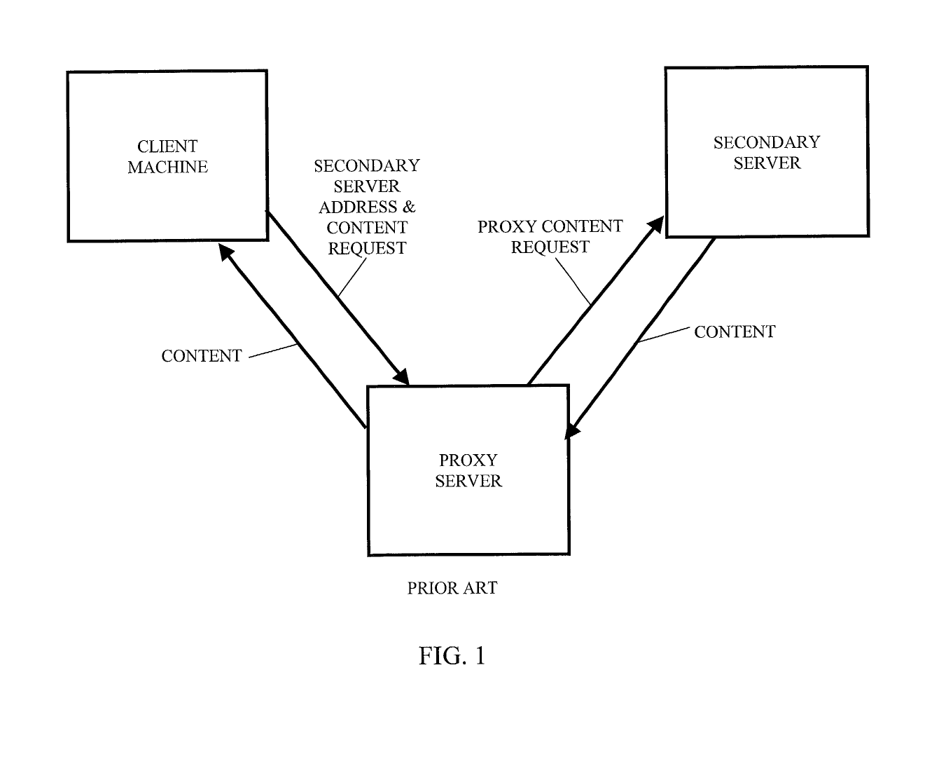

Thus, in contrast to the traditional proxy server shown in FIG. 1, the client machine 110 does not need to know, or even identify to the proxy server 120, the name or address of the secondary server 140 that actually contains the content corresponding to the content request 112. Nor does the client machine 110 intend or care whether the proxy server 120 contacts a secondary server 140 to obtain the content 124 that corresponds to the content request 112.

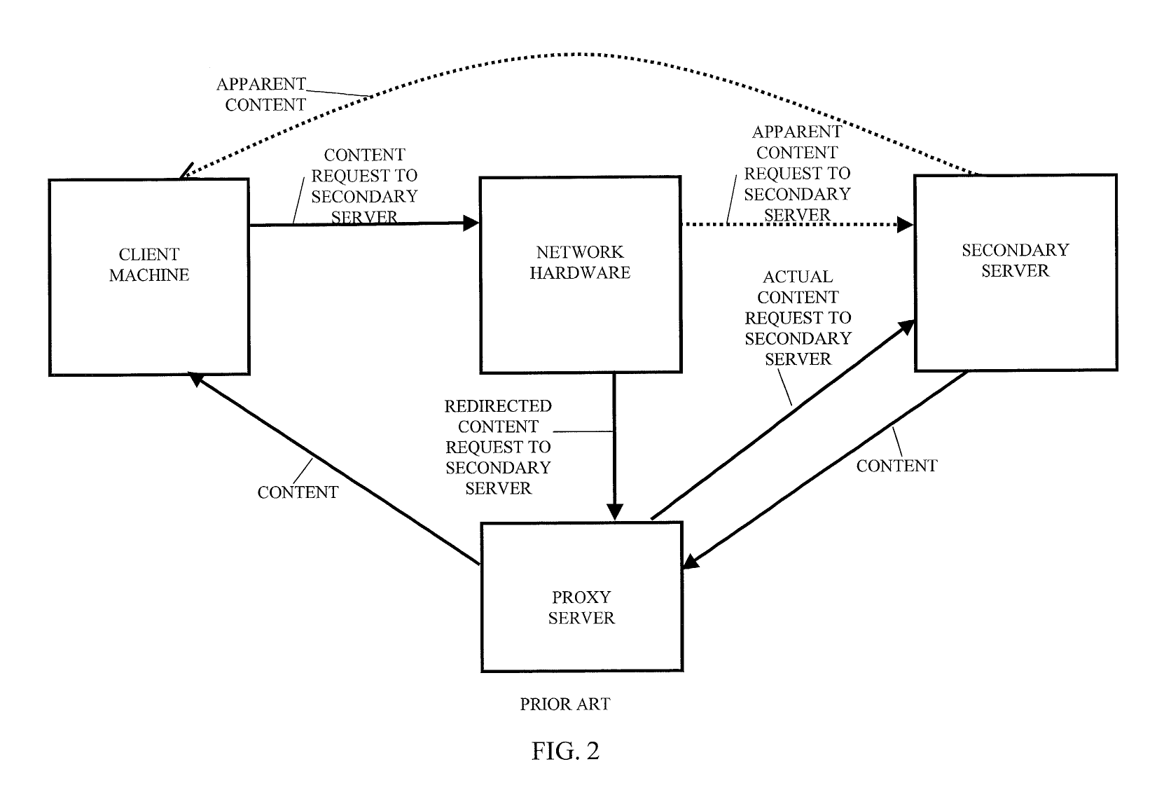

Moreover, the interactions between the proxy server 120 and the secondary server 140 are transparent to the client machine 110. However, in contrast to the conventional transparent proxy server shown in FIG. 2, where the client wishes to communicate with a secondary server but ends up communicating with a proxy server, according to the systems and methods of this invention, the client machine 110 according to the systems and methods of this invention actually intends to communicate with the proxy server 120, not any of the secondary servers 140.

Thus, according to the systems and methods of this invention, in various exemplary embodiments, the proxy server 120 connects to one or more secondary servers 140 to obtain the content that the user has requested, without the user ever knowing to which particular secondary server 140 the proxy server 120 was connected to obtained the requested content, or even whether or not the proxy server 120 has to connect to some secondary server 140 to obtain the requested content.

It should be appreciated that, in various other exemplary embodiments, the content storage device 130 can be omitted from the proxy server 120. In this case, the proxy server 120 has no native content that can be provided to the client machine as the content 124 in response to the request 122. As a result, the proxy server 120 would need to obtain all requested content from the various secondary servers 140 of the network 100.

It should also be appreciated that, in various exemplary embodiments, the proxy server 120 can contain, as part of the content storage device 130, a list or table of secondary servers 140 and the actual content, and/or the categories of content, that can be obtained from each such secondary server 140. It should further be appreciated that, if the content storage device is to be omitted because the content storage device 130 will not be used to store content, the content storage device 130 can be nonetheless retained to store this list or table of the secondary servers 140 and the actual content that can be obtained from each such secondary server 140.

It should further be appreciated that, in various exemplary embodiments, the proxy server 120 can obtain the content corresponding to the content request 112, when the proxy server 120 either does not contain that content in the content storage device 130, or the content storage device 130 is either omitted or is not used to store content, by generating one or more web searches to identify one or more secondary servers 140 that contain the content corresponding to the content request 112. It should also be appreciated that this can be used to augment the list or table of secondary servers 140 discussed above, should the list or table of secondary servers 140 fail to identify a secondary server 140 that contains the requested content.

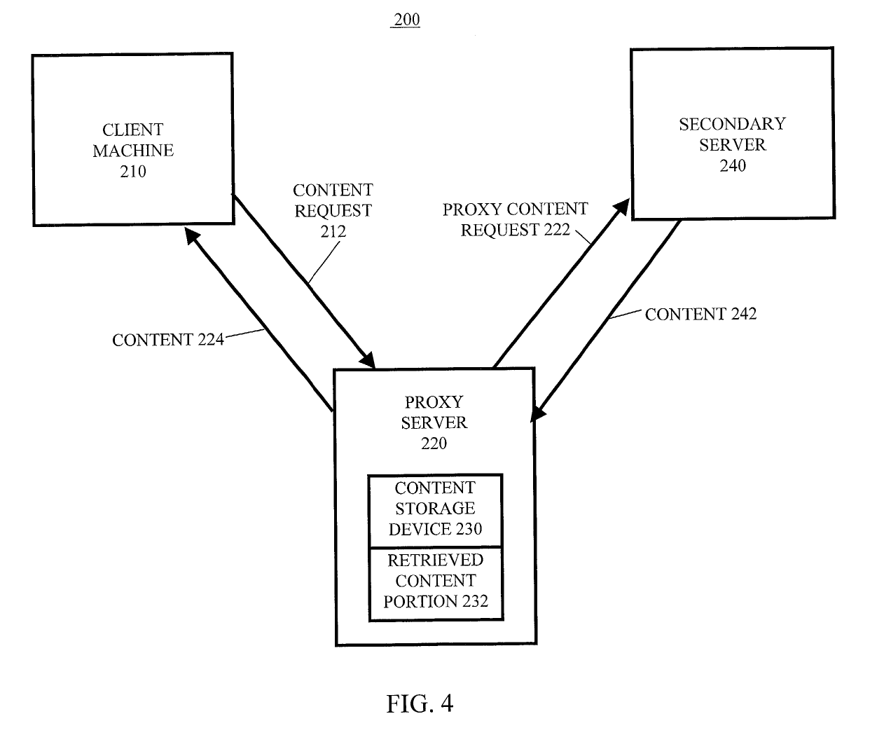

FIG. 4 is a block diagram of a network 200 including a second exemplary embodiment of a proxy server 220 according to this invention. As shown in FIG. 4, the network 200 includes a client machine 210, the proxy server 220 and any number of distinct secondary servers 240. The client machine 210 generates one or more requests 212 for content and directs these requests 212 directly to the proxy server 220. The proxy server 220 receives these requests 212 and transmits the requested content 224 back to the client machine.

Conventionally, the proxy server 220 would be able to transmit the requested content to the client machine 210 only if the requested content were previously stored in a content storage device 230 of the proxy server 220. Otherwise, the proxy server 220 would transmit an error message to the client machine 210.

In contrast, according to the systems and methods of this invention, if the proxy server 220 does not currently contain in the content storage device 230 the content identified in the request 212 from the client machine 210, the proxy server 220 contacts one of the secondary servers 240 of the network 200 that contains the requested content. In particular, the proxy server 220 generates a new request 222 and directs that request 222 to a particular one of the secondary servers 240 that is known to contain the content identified in the request 212. This secondary server 240, in response to the request 222, transmits the requested content 242 to the proxy server 220. The proxy server then retransmits the content received from the secondary server 240 to the client machine as the content 224.

At the same time, in this second exemplary embodiment of the proxy server 220, the proxy server 220 also stores the content received from the secondary server 240 into a retrieved content portion 232 of the content storage device 230. Thus, the next time the client 210 transmits a request 212 to the proxy server 220 for that content, the proxy server 220 will have that content stored in the retrieved content portion 232 of the content storage device 230 as native content. As a result, the proxy server 220 will not need to connect to the appropriate secondary server 240 from which that content 242 was originally obtained, and will be able to immediately transmit the content 224 in response to the request 212.

It should be appreciated that, in various exemplary embodiments, the content storage device 230 can initially contain no native content. In this case, the proxy server 220 initially has no native content that can be provided to the client machine 210 as the content 224 in response to the request 212. As a result, the first time the proxy server 220 receives a request 212 for any particular content, the proxy server 220 would need to obtain that requested content 242 from one of the secondary servers 240 of the network 200. Thereafter, that requested content 242 would then be stored in the retrieved content portion 232 of the content storage device 230 as native content.

It should also be appreciated that, in various exemplary embodiments, the proxy server 220 can contain, as part of the content storage device 230, a list or table of secondary servers 240 and the actual content, and/or the categories of content, that can be obtained from each such secondary server 240.

It should further be appreciated that, if the content 242 in the retrieved content portion 232 of the content storage device 230 that was obtained from a secondary server 240 has become “stale”, when a next request 212 for that content 242 is received by the proxy server 220, the proxy server 220 can “refresh” that obtained content 242 stored in the retrieved content portion 232 of the content storage device 230 by again connecting with the appropriate secondary server 240 to obtain a current version of that content 242. The proxy server 220 would then replace the “stale” version of that content 242 in the content storage device 230 with the current version of that content 242.

It should be appreciated that the proxy server 220 can use any known or later-developed method or technique to determine whether or not the content 242 that is stored in the retrieved content portion 232 is “stale” when a content request 212 that corresponds to that content 242 is received by the proxy server 220. For example, in various exemplary embodiments, the proxy server 220 can determine that the content 242 corresponding to a particular content request 212 stored in the retrieved content portion 232 is “stale” based on one or more of the length of time that the content 242 has been stored in the retrieved content portion 232, the type of the content 242 stored in the retrieved content portion 232, expiration information embedded in the content 242 stored in the retrieved content portion 232, an explicit request in the received content request 212 for updated content, or the like.

It should further be appreciated that, in various exemplary embodiments, the proxy server 220 can obtain the content 224 corresponding to the content request 212, when the proxy server 220 either does not contain the content 242 corresponding to that content request 212 in the retrieved content portion 232 of the content storage device 230, or the version of the content 242 in the retrieved content portion 232 of the content storage device 230 is “stale”, by generating one or more web searches to identify one or more secondary servers 240 that contain the content 242 corresponding to that content request 212. It should also be appreciated that this can be used to augment the list or table of secondary servers 240 discussed above, should the list or table of secondary servers 240 fail to identify a secondary server 140 that contains the content 242 corresponding to that content request 212.

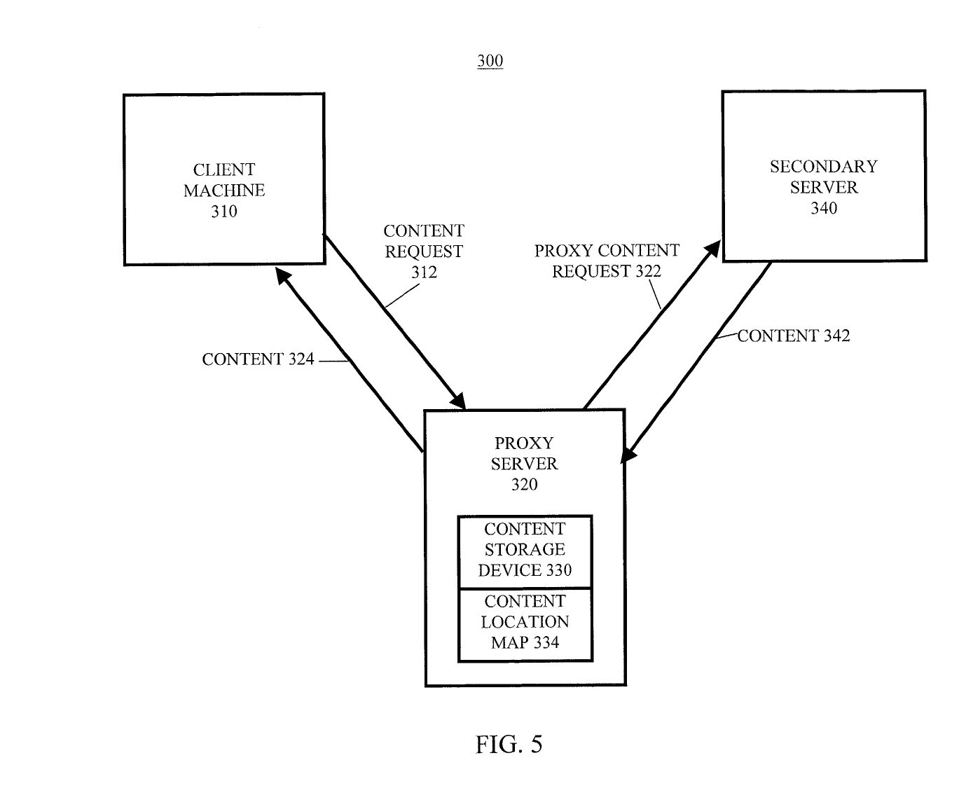

FIG. 5 is a block diagram of a network 300 including a third exemplary embodiment of a proxy server 320 according to this invention. As shown in FIG. 5, the network 300 includes a client machine 310, the proxy server 320 and any number of distinct secondary servers 340. The client machine 310 generates one or more requests 312 for content and directs these requests 312 directly to the proxy server 320. The proxy server 320 receives these requests 312 and transmits the requested content 324 back to the client machine.

Conventionally, the proxy server 320 would be able to transmit the requested content to the client machine 310 only if the requested content were previously stored in a content storage device 330 of the proxy server 320. Otherwise, the proxy server 320 would transmit an error message to the client machine 310.

In contrast, according to the systems and methods of this invention, if the proxy server 320 does not currently contain in the content storage device 330 the content identified in the request 312 from the client machine 310, the proxy server 320 contacts one of the secondary servers 340 of the network 300 that contains the requested content. In particular, the proxy server 320 generates a new request 322 and directs that request 322 to a particular one of the secondary servers 340 that is known to contain the content identified in the request 312. This secondary server 340, in response to the request 322, transmits the requested content 342 to the proxy server 320. The proxy server then retransmits the content received from the secondary server 340 to the client machine as the content 324.

In this third exemplary embodiments, the proxy server 320 contains, as part of the content storage device 330, a list or table, or, more generally, a content location map 334, of secondary servers 340 and the actual content, and/or the categories of content, that can be obtained from each such secondary server 340. Furthermore, in this third exemplary embodiment, as the proxy server 320 obtains content 342 from various ones of the secondary servers 340, the proxy server 320 updates the content location map 334, such that the content location map 334 forms a mapping of the various secondary servers 340 and the content 342, and/or one or more categories of content 342, that each secondary server 340 contains. As a result, if the proxy server 320 needs to obtain a more current version of the content 342 that corresponds to a particular content request 312 that is currently stored in the content storage device 330, the proxy server 320 can use the content location map 334 to identify which secondary server 340 stores the content to be updated. Similarly, if the proxy server 320 receives a content request 312 for content 342 that is not stored in the content storage device 330, the proxy server 320 can consult the content location map 334 to identify which one or more of the secondary servers 340 have similar content and/or to identify which one or more of the secondary servers 340 store the appropriate category of content and thus might store the content that corresponds to a particular content request 312.

It should be appreciated that, in various exemplary embodiments, the proxy server 320 according to this third exemplary embodiment can be combined with the second exemplary embodiment of the proxy server 220. In this case, the proxy server 320 also stores the content received from the secondary server 340 into a retrieved content portion 232 of the content storage device 330. Thus, the next time the client 310 transmits a request 312 to the proxy server 320 for that content, the proxy server 320 will have that content stored in the content storage device 330 as native content. As a result, the proxy server 320 will not need to connect to the appropriate secondary server 340 from which that content 342 was originally obtained, and will be able to immediately transmit the content 324 in response to the content request 312.

It should be appreciated that, in various exemplary embodiments, the content storage device 330 can initially contain no native content. In this case, the proxy server 320 initially has no native content that can be provided to the client machine as the content 324 in response to the request 312. As a result, the first time the proxy server 320 receives a request 312 for any particular content, the proxy server 320 would need to obtain the content corresponding to that particular content request 312 from one of the secondary servers 340 of the network 300. Thereafter, the content corresponding to that particular content request 312 would then be stored in the content storage device 330 as native content.

It should further be appreciated that, as the content 342 in the content storage device 330 that was obtained from a secondary server 340 has become “stale”, when a next request 312 for the content 342 corresponding to that particular content request 312 is received by the proxy server 320, the proxy server 320 can “refresh” the obtained content 342 corresponding to that particular content request 312 stored in the content storage device 330 by again connecting with the appropriate secondary server 340 to obtain a current version of the content 342 corresponding to that particular content request 312. The proxy server 320 would then replace the “stale” version of the content 342 corresponding to that particular content request 312 in the content storage device 330 with the current version of the content 342 corresponding to that particular content request 312.

It should further be appreciated that, in various exemplary embodiments, the proxy server 320 can obtain the content 342 corresponding to that particular content request 312, when the proxy server 320 either does not contain the content corresponding to that particular content request 312 in the content storage device 330, or the version of the content 342 corresponding to that particular content request 312 in the content storage device 330 is “stale”, by generating one or more web searches to identify one or more secondary servers 340 that contain the content 342 corresponding to that particular content request 312. It should also be appreciated that this can be used to augment the content location map 334 of the secondary servers 340 discussed above, should the content location map 334 of the secondary servers 340 fail to identify a secondary server 140 that contains the content 342 corresponding to that particular content request 312. Moreover, beyond merely augmenting the content location map 334, the results of the search can be incorporated into the content location map 334 so that that search is memorialized, and thus the results immediately available to the proxy server 300 without having to re-run that search.

Thus, the list or table 334 acts as a map of the secondary servers 340 and the content and/or categories of content obtainable from those secondary servers 340. Moreover, if the proxy server 320 finds, or is unable to find, the content 342 corresponding to that particular content request 312 on a particular one of the secondary server 340, the proxy server 320 can add that information to the content location map 334. Thus, the content location map 334 will also indicate information about success and failure of various secondary servers 340 to supply various elements of requested content. The proxy server 320 could then use this information to make decisions about which secondary servers 340 to contact first or last to obtain the content 342 that corresponds to any particular content request 312.

As well as streaming and proxy functionality, the proxy servers 120-320 also possesses the ability to cache streaming content. This allows this content to migrate onto the edge of the network, where the content will remain for more than one use. Caching allows bandwidth consumption to be minimized across expensive wide area network links, or on more saturated internal backbones. This translates to a significant cost advantage over conventional delivery systems across a network infrastructure.

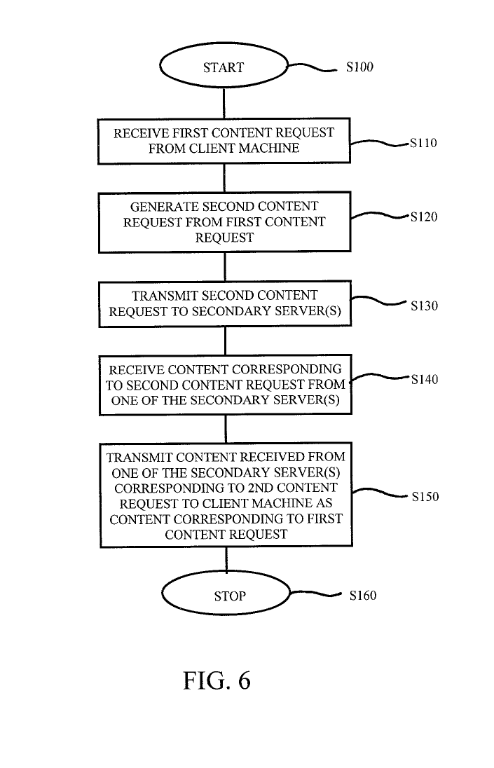

FIG. 6 is a flowchart outlining a first exemplary embodiment of a method for responding to a content request according to this invention. As shown in FIG. 6, the method begins in step S100 and continues to step S110, where a first content request is received from a first client machine. Then, in step S120, a second content request is generated from the first content request. Next, in step S130, the second content request is transmitted to one or more secondary servers. In general, but not necessarily, the secondary servers to which the second content request is transmitted are those secondary servers either known or believed to store content corresponding to the second content request. Operation then continues to step S140.

In step S140, content corresponding to the second content request is received from one of the one or more secondary servers to which the second content request was transmitted. Next, in step S150, the content received from the one of the one or more secondary servers in response to the second content request is transmitted to the requesting client machine as the content that corresponds to the first content request received from the client machine. Then, in step S160, operation of the method stops.

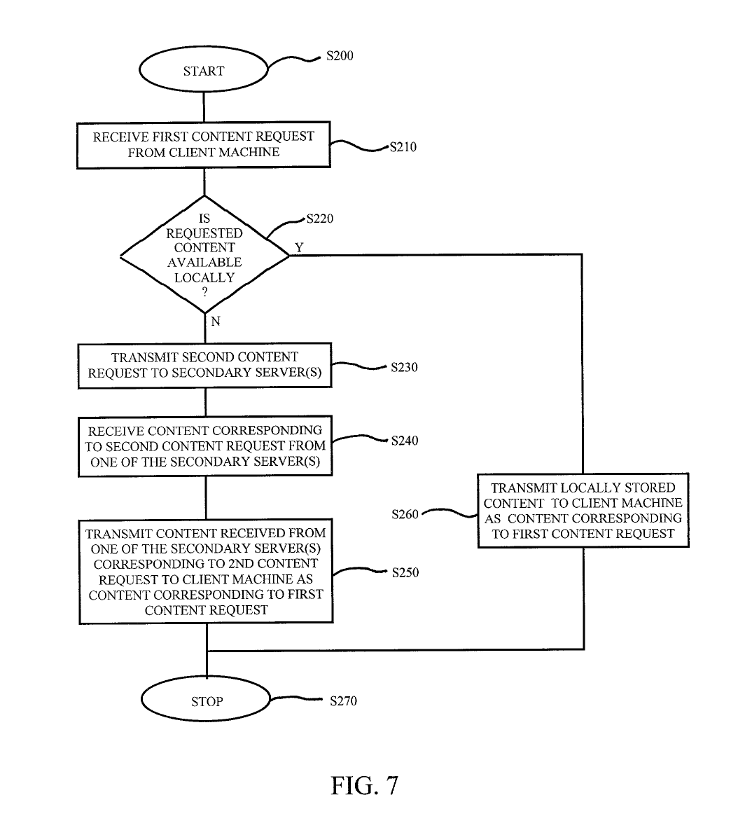

FIG. 7 outlines a second exemplary embodiment of the method for responding to a content request according to this invention. As shown in FIG. 7, operation of the method begins in step S200, and continues to step S210, where the first content request is received from the client machine. Then, in step S220, a determination is made whether the content corresponding to the received first content request is available locally at the recipient. If so, operation jumps from step S220 to step S260. Otherwise, operation continues to step S230.

In step S230, a second content request is transmitted to one or more secondary servers, such as those secondary servers that are known or believed to contain content corresponding to the first content request. Next, in step S240, content corresponding to the second content request is received from one of the one or more secondary servers. Then, in step S250, the content corresponding to the second content request that was received from the one of the one or more secondary servers is transmitted to the client machine as the content corresponding to the first content request. Operation then continues to step S270.

In contrast, in step S260, the locally stored content is transmitted to the client machine as the content corresponding to the first content request. Then, in step S270, operation of the method ends.

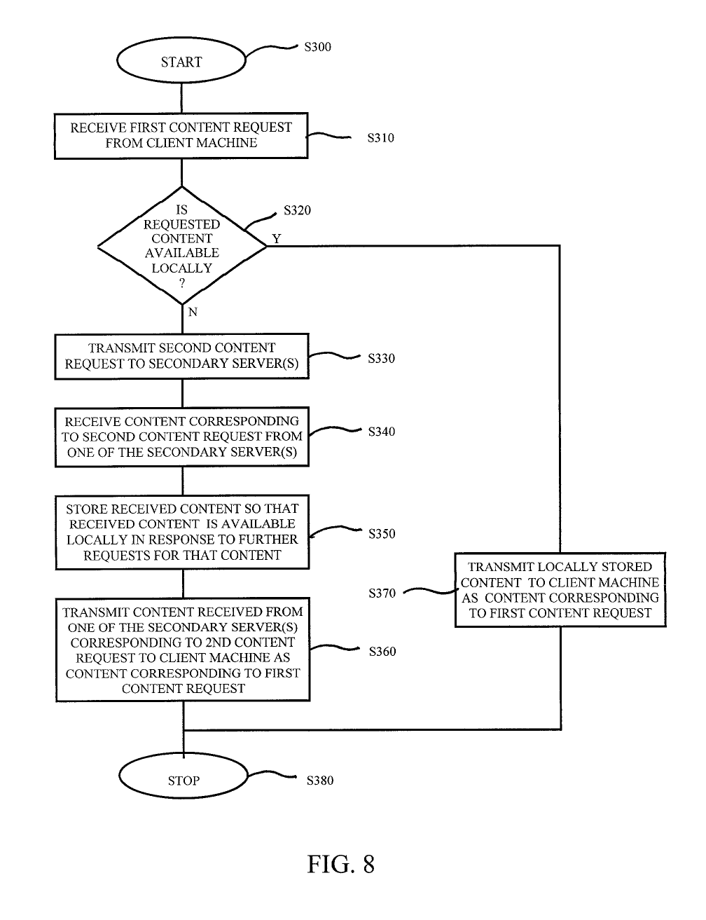

FIG. 8 is a flowchart outlining a third exemplary embodiment of the method for responding to a content request according to this invention. As shown in FIG. 8, beginning in step S300, operation continues to step S310, where a first content request is received from a client machine. Then, in step S320, a determination is made whether the content corresponding to the received first content request is available locally at the recipient. If so, operation jumps from step S320 to step S370. Otherwise, operation continues to step S330.

In step S330, a second content request is transmitted to one or more secondary servers that are known or believed to contain content corresponding to the first content request. Next, in step S340, content corresponding to the second content request is received from one of the one or more secondary servers. Then, in step S350, the content corresponding to the second request received from the one of the one or more secondary servers in response to the second content request is stored locally so that the received content is available locally should there be any further requests from the client machine for that content. That is, in response to further requests for that content, that content can be supplied without having to generate a second content request for that content. Operation then continues to step S360.

In step S360, the content corresponding to the second content request that was received from the one of the one or more secondary servers is transmitted to the client machine as the content corresponding to the first content request. Operation then jumps to step S380. In contrast, in step S370, the locally stored content is transmitted to the client machine as the content corresponding to the first content request. Then, in step S380, operation of the method ends.

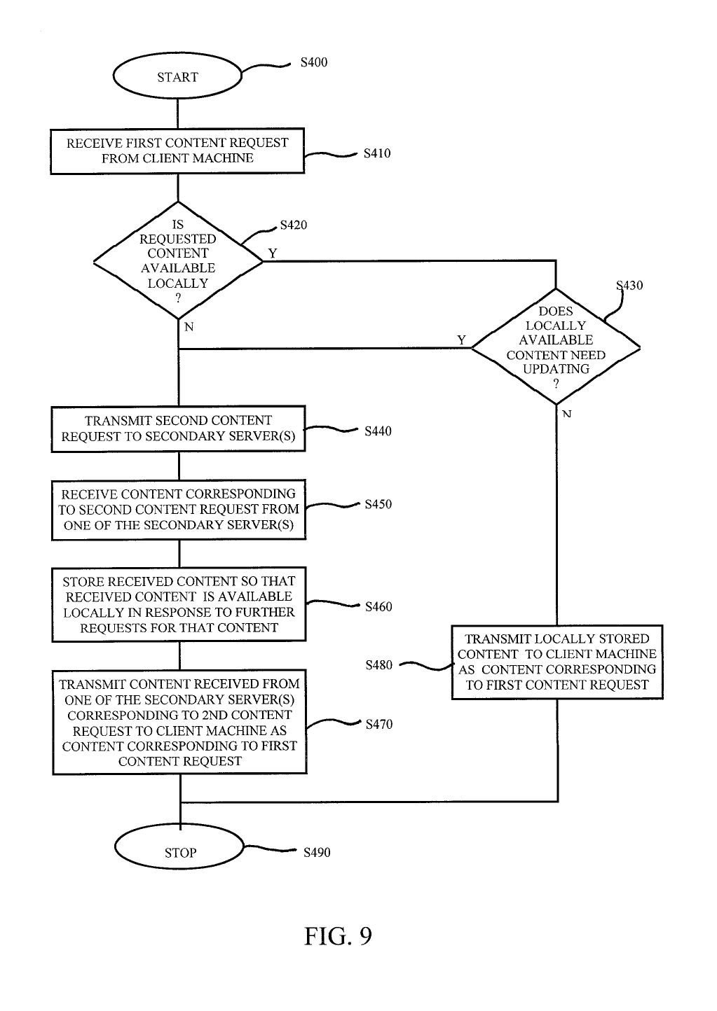

FIG. 9 is a flowchart outlining a fourth exemplary embodiment of the method for responding to a content request according to this invention. As shown in FIG. 9, operation of the method begins in step S400, and continues to step S410, where a first content request is received from a client machine. Then, in step S420, a determination is made whether the content corresponding to the first content request is available locally at the recipient. If not, operation jumps directly to step S440. Otherwise, if the content corresponding to the first content request is available locally, operation continues to step S430.

In step S430, a determination is made whether the locally available content corresponding to the first content request needs to be updated. If so, operation continues to step S440, otherwise, operation jumps to step S480. It should be appreciated that the locally available content corresponding to the first content request may need to be updated for any of a variety of reasons. For example, an expiration date embedded in the content may have expired. Alternatively, the length of time that the locally available content has been stored locally may be greater than a predetermined or dynamically determined time limit, or the content may be the type of content that is always updated in response to a further request for that content. Additionally, the first content request could have been received with an explicit indication that updated content is desired or required.

In step S440, a second content request is transmitted to one or more secondary servers that are known or believed to contain content corresponding to the first content request. Next, in step S450, content corresponding to the second content request is received from one of the one or more secondary servers. Then, in step S460, the content corresponding to the second request received from the one of the one or more secondary servers in response to the second content request is stored locally so that the received content is available locally should there be any further requests from the client machine for that content. That is, in response to further requests for that content, that content can be supplied without having to generate a second content request for that content. Operation then continues to step S470.

In step S470, the content corresponding to the second content request that was received from the one of the one or more secondary servers is transmitted to the client machine as the content corresponding to the first content request. Operation then jumps to step S490. In contrast, in step S480, the locally stored content is transmitted to the client machine as the content corresponding to the first content request. Then, in step S490, operation of the method ends.

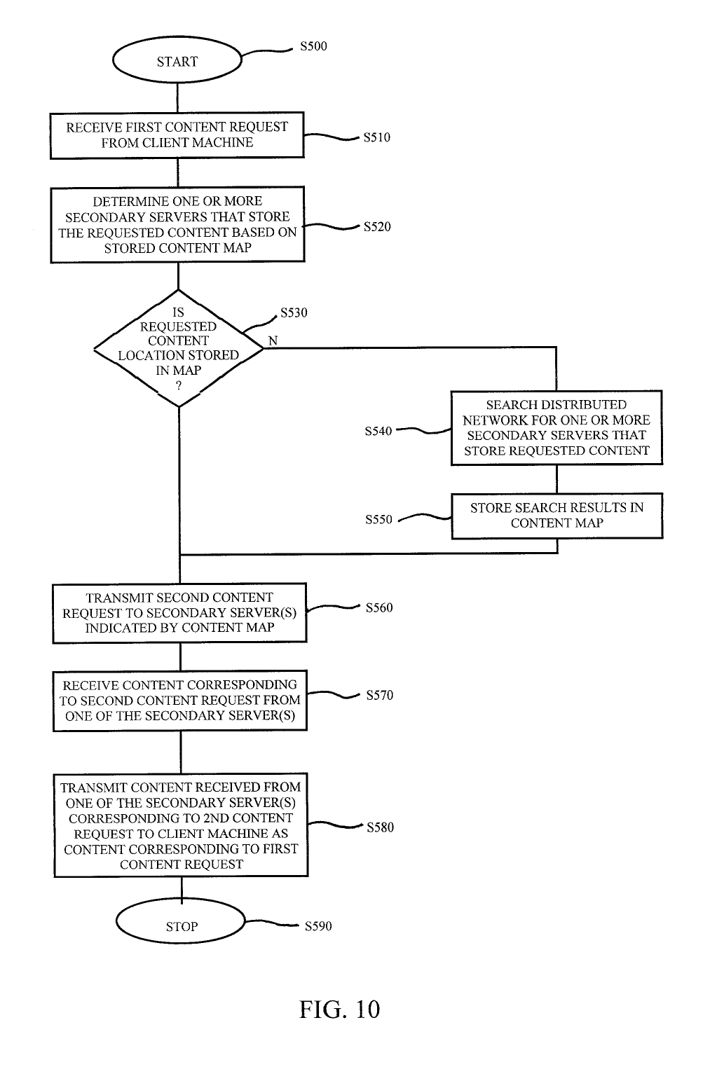

FIG. 10 is a flowchart outlining a fifth exemplary embodiment of a method for responding to a content request according to this invention. As shown in FIG. 10, operation of the method begins in step S500, and continues to step S510, where a first content request from a client machine is received. Then, in step S520, the identity of one or more secondary servers that store content corresponding to the first content request are determined based on a stored content map. Next, in step S530, a determination is made whether a location, i.e., one of the available secondary servers, is stored in the content map for the content corresponding to the first content request. If so, operation jumps to step S560. Otherwise, operation continues to step S540.

In step S540, a search query is developed and the distributed network to which the recipient is connected is searched to identify one or more secondary servers that store content corresponding to the first content request. Next, in step S550, the search results obtained from searching the distributed network for the content corresponding to the first content request is stored in the content map. Operation then continues to step S560.

In step S560, a second content request is transmitted to one or more secondary servers based on the information contained in the content map. Then, in step S570, content corresponding to the second content request is received from one of the one or more secondary servers to which the second content request was transmitted. Next, in step S580, the content corresponding to the second content request received from the one of the one or more secondary servers is transmitted to the client machine as the content corresponding to the first content request. Then, in step S590, operation of the method ends.

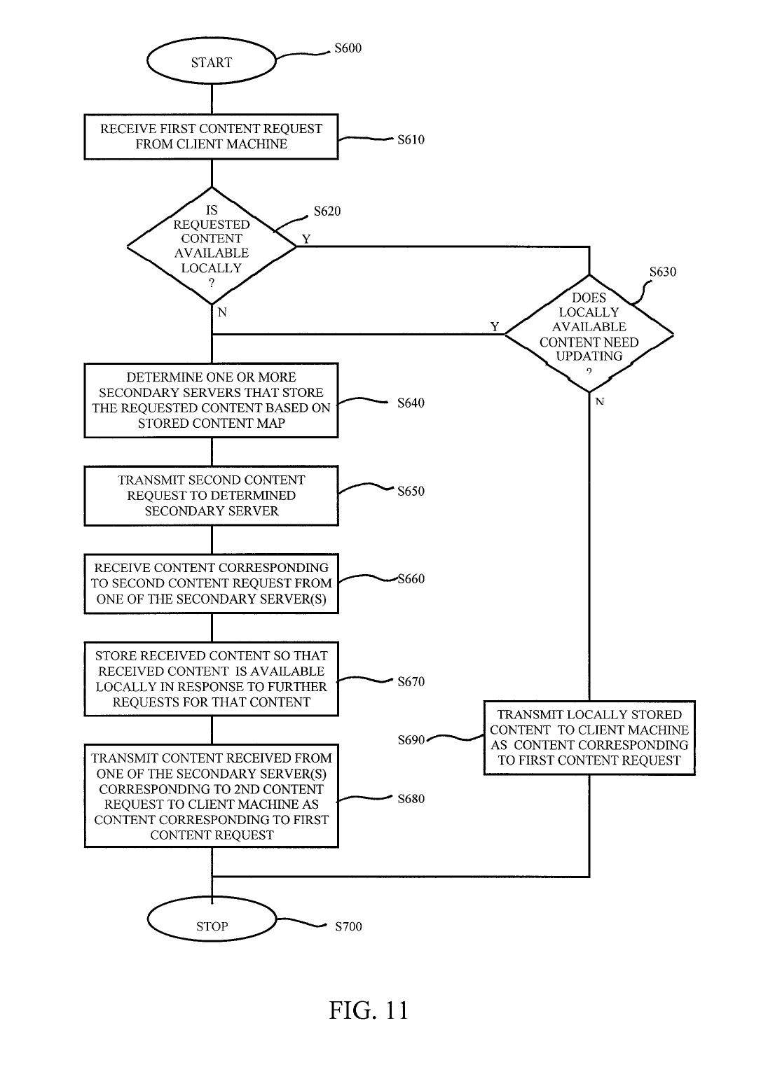

FIG. 11 is a flowchart outlining a sixth exemplary embodiment of a method for responding to content requests according to this invention. As shown in FIG. 11, operation of the method begins in step S600, and continues to step S610, where a first content request from a client machine is received. Then, in step S620, a determination is made whether the content corresponding to the first content request is available locally at the recipient. If not, operation jumps directly to step S640. Otherwise, if the content corresponding to the first content request is available locally, operation continues to step S630.

In step S630, a determination is made whether the locally available content corresponding to the first content request needs to be updated. If so, operation continues to step S640, otherwise, operation jumps to step S690. It should be appreciated that the locally available content corresponding to the first content request may need to be updated for any of a variety of reasons. For example, an expiration date embedded in the content may have expired. Alternatively, the length of time that the locally available content has been stored locally may be greater than a predetermined or dynamically determined time limit, or the content may be the type of content that is always updated in response to a further request for that content. Additionally, the first content request could have been received with an explicit indication that updated content is desired or required.

In step S640, one or more secondary servers that store the requested content based on a stored content map are determined. It should be appreciated that the determination in step S640 can be implemented as outlined above with respect to steps S520-S550 in FIG. 10. Next, in step S650, a second content request is transmitted to the determined one or more secondary servers. Then, in step S660, content corresponding to the second content request is received from one of the one or more secondary servers. Operation then continues to step S670.

In step S670, the content corresponding to the second request received from the one of the one or more secondary servers in response to the second content request is stored locally so that the received content is available locally should there be any further requests from the client machine for that content. That is, in response to further requests for that content, that content can be supplied without having to generate a second content request for that content. Next in step S680, the content corresponding to the second content request that was received from the one of the one or more secondary servers is transmitted to the client machine as the content corresponding to the first content request. Operation then jumps to step S700. In contrast, in step S690, the locally stored content is transmitted to the client machine as the content corresponding to the first content request. Then, in step S700, operation of the method ends.

The various proxy servers 120-320 are, in various exemplary embodiments, implemented on a programmed general purpose computer. However, the various proxy servers 120-320 can also be implemented on a special purpose computer, a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA or PAL, or the like. In general, any device, capable of implementing a finite state machine that is in turn capable of implementing any of the flowcharts shown in FIGS. 6-11, can be used to implement the various proxy servers 120-320.

The various storage devices 130-330 can be implemented using any appropriate combination of alterable, volatile or non-volatile memory or non-alterable, or fixed, memory. The alterable memory, whether volatile or non-volatile, can be implemented using any one or more of static or dynamic RAM, a floppy disk and disk drive, a writable or re-rewriteable optical disk and disk drive, a hard drive, flash memory or the like. Similarly, the non-alterable or fixed memory can be implemented using any one or more of ROM, PROM, EPROM, EEPROM, an optical ROM disk, such as a CD-ROM or DVD-ROM disk, and disk drive or the like.

It should be understood the various proxy servers 120-320 shown in FIGS. 3-5 can be implemented as portions of a suitably programmed general purpose computer. Alternatively, each of the various proxy servers 120-320 shown in FIGS. 3-5 can be implemented as physically distinct hardware circuits within an ASIC, or using a FPGA, a PDL, a PLA or a PAL, or using discrete logic elements or discrete circuit elements. The particular form each of the various proxy servers 120-320 in FIGS. 3-5 will take is a design choice and will be obvious and predicable to those skilled in the art.

Moreover, each of the various proxy servers 120-320 can be implemented as software executing on a programmed general purpose computer, a special purpose computer, a microprocessor or the like. In this case, each of the various proxy servers 120-320 can be implemented as a resource residing on a server or the like. Each of the various proxy servers 120-320 can also be implemented by physically incorporating it into a software and/or hardware system.

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A method for responding to a content request received from a requesting client machine, comprising:
receiving a first content request from the requesting client machine;
generating second content request based on the first content request;
transmitting the second content request to at least one secondary server;
receiving content corresponding to the second content request from at least one of the at least one secondary server; and
forwarding to the requesting client machine the received content as the content corresponding to the first content request.

2. The method of claim 1, further comprising:
determining, before generating the second content request, if the content corresponding to the first content request is locally available; and
forwarding the locally-available content as the content corresponding to the first content request in place of performing the generating, transmitting, receiving and received content forwarding steps.

3. The method of claim 2, further comprising locally storing the received content corresponding to the second content request, the locally-stored received content being locally available to a subsequent content request from the requesting client machine requesting content at least similar to the first content request.

4. The method of claim 3, further comprising:
determining, if the content corresponding to the first content request is locally available, whether to update the locally available content corresponding to the first content request;
forwarding the locally-available content as the content corresponding to the first content request in place of performing the generating, transmitting, receiving and received content forwarding steps if the locally available content is not to be updated; and
performing the generating, transmitting, receiving and received content forwarding steps if the locally available content is to be updated.

5. The method of claim 4, wherein determining whether to update the locally available content corresponding to the first content request comprises at least one of:
determining if the locally available content corresponding to the first content request is older than an update age;
determining if the locally available content corresponding to the first content request is a type of content that is to be update automatically;
determining if the locally available content corresponding to the first content request includes expiration information; and
determining if the content request includes an indication to update the locally available content.

6. The method of claim 4, further comprising:
determining whether at least one secondary server is known to store at least a type of content that corresponds to the content corresponding to the first content request based on a stored content map;
searching, if at least one secondary server is not known a plurality of secondary servers to identify at least one secondary server that contains at least a type of content that corresponds to the content corresponding to the first content request;
adding, in response to the searching step, to the stored content map the at least one identified secondary server located by the search; and
transmitting, based on the at least one secondary server identified in the content map, the second content request to that at least one secondary server in response to either the adding step or the at least one secondary server determining step.

7. The method of claim 2, further comprising:
determining whether at least one secondary server is known to store at least a type of content that corresponds to the content corresponding to the first content request based on a stored content map;
searching, if at least one secondary server is not known a plurality of secondary servers to identify at least one secondary server that contains at least a type of content that corresponds to the content corresponding to the first content request;
adding, in response to the searching step, to the stored content map the at least one identified secondary server located by the search; and
transmitting, based on the at least one secondary server identified in the content map, the second content request to that at least one secondary server in response to either the adding step or the at least one secondary server determining step.

8. The method of claim 1, further comprising:
determining whether at least one secondary server is known to store at least a type of content that corresponds to the content corresponding to the first content request based on a stored content map;
searching, if at least one secondary server is not known a plurality of secondary servers to identify at least one secondary server that contains at least a type of content that corresponds to the content corresponding to the first content request;
adding, in response to the searching step, to the stored content map the at least one identified secondary server located by the search; and
transmitting, based on the at least one secondary server identified in the content map, the second content request to that at least one secondary server in response to either the adding step or the at least one secondary server determining step.

9. The method of claim 1, further comprising locally storing the received content corresponding to the second content request.

10. The method of claim 9, further comprising:
determining whether at least one secondary server is known to store at least a type of content that corresponds to the content corresponding to the first content request based on a stored content map;
searching, if at least one secondary server is not known a plurality of secondary servers to identify at least one secondary server that contains at least a type of content that corresponds to the content corresponding to the first content request;
adding, in response to the searching step, to the stored content map the at least one identified secondary server located by the search; and
transmitting, based on the at least one secondary server identified in the content map, the second content request to that at least one secondary server in response to either the adding step or the at least one secondary server determining step.

11. A system usable to respond to a content request received from a requesting client machine, comprising a proxy server able to receive the content request and generate and transmit a second content request to at least one secondary server and able to receive the content from at least one of the at least one secondary server and transmit the received content to the requesting content machine as the content corresponding to the requesting client machine.

12. The system of claim 11, further comprising a storage device usable to store content locally relative to the proxy server.

13. The system of claim 12, wherein the proxy server determines whether content corresponding to the first content request is stored in the storage device, such that, when content corresponding to the first content request is stored in the storage device, the proxy server transmits the content stored in the storage device corresponding to the first content request to the requesting client machine as the content corresponding to the first content request.

14. The system of claim 12, wherein the proxy server determines, for a particular content stored in the storage device, whether to update that particular content stored in the storage device in response to receiving a content request to which that particular content corresponds.

15. The system of claim 14, wherein, when the proxy server determine to update the content, the proxy server transmits a second content request to which that particular content corresponds to at least one secondary server.

16. The system of claim 12, further comprising a content map that indicates, for at least some content requests, at least one secondary server known to store at least a type of content that corresponds to that content request.

17. The system of claim 16, wherein the proxy server determines the at least one secondary server to which the second content request is transmitted based on the content map.

18. The system of claim 16, wherein the proxy server determines whether the content map indicates at least one secondary server known to store at least a type of content that corresponds to the content corresponding to the first content request, the proxy server generating a search of a plurality of secondary servers if the content map does not indicates at least one secondary server known to store at least a type of content that corresponds to the content corresponding to the first content request, the proxy server updating the content map based on results of the search.

19. The system of claim 11, further comprising a content map that indicates, for at least some content requests, at least one secondary server known to store at least a type of content that corresponds to that content request.

20. The system of claim 19, wherein the proxy server determines the at least one secondary server to which the second content request is transmitted based on the content map.

21. The system of claim 19, wherein the proxy server determines whether the content map indicates at least one secondary server known to store at least a type of content that corresponds to the content corresponding to the first content request, the proxy server generating a search of a plurality of secondary servers if the content map does not indicates at least one secondary server known to store at least a type of content that corresponds to the content corresponding to the first content request, the proxy server updating the content map based on results of the search.

22. A system usable to respond to a content request received from a requesting client machine, comprising:
means for receiving a first content request from the requesting client machine;
means for generating and transmitting a second content request to at least one secondary server corresponding to the first content request;
means for receiving content corresponding to the second content request from at least one of the at least one secondary server; and
means for transmitting the received content to the requesting content machine as the content corresponding to the first content request.

23. The system of claim 23, further comprising storing means for storing content locally relative to the means for receiving.

24. The system of claim 23, further comprising means for determining whether content corresponding to the first content request is stored in the storing means, such that, when content corresponding to the first content request is stored in the storing means, the means for transmitting the received content transmits the content stored in the storage means corresponding to the first content request to the requesting client machine as the content corresponding to the first content request.

25. The system of claim 23, further comprising updating means for determining, for a particular content stored in the storing means, whether to update that particular content stored in the storing means in response to receiving a content request to which that particular content corresponds.

26. The system of claim 25, wherein, when the updating means determines to update the content, the means for generating and transmitting transmits a second content request to which that particular content corresponds to at least one secondary server.

27. The system of claim 23, further comprising a content map that indicates, for at least some content requests, at least one secondary server known to store at least a type of content that corresponds to that content request.

28. The system of claim 27, wherein the means for generating and transmitting determines the at least one secondary server to which the second content request is transmitted based on the content map.

29. The system of claim 27, wherein the means for generating and transmitting determines whether the content map indicates at least one secondary server known to store at least a type of content that corresponds to the content corresponding to the first content request, the means for generating and transmitting generating a search of a plurality of secondary servers if the content map does not indicates at least one secondary server known to store at least a type of content that corresponds to the content corresponding to the first content request, the means for generating and transmitting updating the content map based on results of the search.

30. The system of claim 22, further comprising a content map that indicates, for at least some content requests, at least one secondary server known to store at least a type of content that corresponds to that content request.

31. The system of claim 30, wherein the means for generating and transmitting determines the at least one secondary server to which the second content request is transmitted based on the content map.

32. The system of claim 30, wherein the means for generating and transmitting determines whether the content map indicates at least one secondary server known to store at least a type of content that corresponds to the content corresponding to the first content request, the means for generating and transmitting generating a search of a plurality of secondary servers if the content map does not indicates at least one secondary server known to store at least a type of content that corresponds to the content corresponding to the first content request, the means for generating and transmitting updating the content map based on results of the search.
